(19) United States
(12) Patent Application Publication
(10) Pub. No.: US 2022/0126529 A1
(43) Pub. Date: Apr. 28, 2022

(54) MATERIAL LAYER FORMING DEVICE

(71) Applicant: Honda Motor Co., Ltd., Tokyo (JP)

(72) Inventors: Naoto ISHII, Tokyo (JP); Yoshihiro KAWAHARA, Tokyo (JP); Satoshi SHINOZAKI, Tokyo (JP)

(73) Assignee: Honda Motor Co., Ltd., Tokyo (JP)

(21) Appl. No.: 17/472,683

(22) Filed: Sep. 12, 2021

(30) Foreign Application Priority Data
Oct. 28, 2020 (JP) 2020-180602

(51) Int. Cl. B29C 70/30; B05B 1/34; B05B 14/10

(52) U.S. Cl. CPC B29C 70/305; B29L 2031/58; B05B 14/10; B05B 1/3402

(57) ABSTRACT

The disclosure provides a material layer forming device that can reduce scattering of a raw material blown out from a nozzle to efficiently deposit the raw material on a required portion of a blowout target surface. A fiber layer forming device 1A is a device that blows out short fibers F1 to a blowout target surface (wall surface 4b) and deposits the short fibers F1 on the blowout target surface to form a sheet-like fiber layer F2. The fiber layer forming device 1A includes a nozzle 10 having a blowout region 11c that blows out the short fibers F1. The nozzle 10 further includes a suction region 12c that is close to the blowout region 11c and sucks the short fibers F1 spreading to the outside of the blowout region 11c, among the short fibers F1 blown out from the blowout region 11c.

### CROSS-REFERENCE TO RELATED APPLICATION

This application claims the priority benefits of Japanese application no. 2020-180602, filed on Oct. 28, 2020. The entirety of the above-mentioned patent application is hereby incorporated by reference herein and made a part of this specification.

### BACKGROUND

### Technical Field

The disclosure relates to a material layer forming device.

### Description of Related Art

Conventionally, there is a device that produces a fiber aggregate by depositing and laminating short fibers on a surface of a mold (see Patent Document 1, for example). In this device, the surface of the mold has air permeability, and while air is sucked by the surface of the mold, the short fibers are blown out from a nozzle toward the surface of the mold. As a result, the short fibers are deposited on the surface of the mold to form a short fiber layer.

### RELATED ART

Patent Document

[Patent Document 1] International Publication No. 2003/021025

### Problems to be Solved

However, the short fibers blown out from the nozzle tend to scatter around the nozzle. The scattered short fibers may be excessively deposited around a range targeted by the nozzle, and the thickness of the fiber layer may become uneven.

### SUMMARY

According to an embodiment of the disclosure, a material layer forming device (for example, the fiber layer forming device 1A of the embodiment) is provided for blowing out a raw material (for example, the short fibers F1 of the embodiment) to a blowout target surface (for example, the wall surface 4b of the embodiment) and depositing the raw material on the blowout target surface to form a sheet-like material layer (for example, the short fiber layer F1 of the embodiment). The material layer forming device includes: a nozzle (for example, the nozzle 10 of the embodiment) having a blowout region (for example, the blowout region 11c of the embodiment) that blows out the raw material. The nozzle further includes a suction region (for example, the suction region 12c of the embodiment) that is close to the blowout region and sucks the raw material spreading to outside of the blowout region, among the raw material blown out from the blowout region.

### BRIEF DESCRIPTION OF THE DRAWINGS

FIG. 1 is an explanatory view showing a molding apparatus to which a material layer forming device according to an embodiment of the disclosure is applied.

FIG. 2 is an explanatory view showing a mold clamped state of the molding apparatus.

FIG. 3 is an explanatory view showing an opened state of the molding apparatus and a molded product.

FIG. 4 is an explanatory view showing main parts of the material layer forming device.

FIG. 5 is a cross-sectional view taken along an axial direction of a material blowout nozzle of the material layer forming device.

FIG. 6 is a cross-sectional view taken along the axial direction of the nozzle, and is a cross-sectional view orthogonal to FIG. 5.

FIG. 7 is a cross-sectional view taken along the line VII-VII of FIG. 5.

FIG. 8 is a cross-sectional view taken along the line VIII-VIII of FIG. 5.

FIG. 9 is a cross-sectional view taken along the line IX-IX of FIG. 5.

FIG. 10 is a cross-sectional view taken along the line IX-IX of FIG. 5, and is a cross-sectional view showing a modified example of a brush.

### DESCRIPTION OF THE EMBODIMENTS

The disclosure provides a material layer forming device that can reduce scattering of a raw material blown out from a nozzle to efficiently deposit the raw material on a required portion of a blowout target surface.

### Means for Solving the Problems

According to an embodiment of the disclosure, a material layer forming device (for example, the fiber layer forming device 1A of the embodiment) is provided for blowing out a raw material (for example, the short fibers F1 of the embodiment) to a blowout target surface (for example, the wall surface 4b of the embodiment) and depositing the raw material on the blowout target surface to form a sheet-like material layer (for example, the short fiber layer F1 of the embodiment). The material layer forming device includes: a nozzle (for example, the nozzle 10 of the embodiment) having a blowout region (for example, the blowout region 11c of the embodiment) that blows out the raw material. The nozzle further includes a suction region (for example, the suction region 12c of the embodiment) that is close to the blowout region and sucks the raw material spreading to outside of the blowout region, among the raw material blown out from the blowout region. According to this configuration, since the raw material blown out from the nozzle is less likely to scatter around the nozzle, the possibility that the thickness of the material layer becomes uneven due to the scattered raw material can be suppressed.

According to an embodiment of the disclosure, the suction region is provided to surround the outside of the blowout region when viewed from a blowout direction of the nozzle. According to this configuration, since the raw material can be quickly sucked outside the blowout region before the raw material scatters to the outside of the nozzle, the possibility that the raw material scatters to the outside of the nozzle can be further suppressed.

According to an embodiment of the disclosure, the nozzle includes: an inner cylinder (for example, the inner cylinder 11 of the embodiment) that forms the blowout region inside; and an outer cylinder (for example, the outer cylinder 12 of the embodiment) that is provided on an outer periphery of the inner cylinder at an interval and forms the suction region between the inner cylinder and the outer cylinder. An axial tip end portion (for example, the axial tip end portion 14a of the embodiment) of the outer cylinder facing the blowout target surface is provided on an axial tip end side with respect to an axial tip end portion (for example, the axial tip end portion 11a of the embodiment) of the inner cylinder facing the blowout target surface. According to this configuration, the nozzle has a double tube structure including the inner and outer cylinders, and the inner cylinder forms the blowout region and the outer cylinder forms the suction region. Since the outer cylinder of the nozzle is provided to be longer than the inner cylinder on the tip end side in the axial direction, it is easy to capture the raw material spreading to the outside of the blowout region, and the possibility that the raw material scatters to the outside of the nozzle can be further suppressed.

According to an embodiment of the disclosure, a portion on an axial tip end side of the outer cylinder is provided with an air permeable capturing portion (for example, the brush 14 of the embodiment) that has air permeability and is capable of capturing the raw material. According to this configuration, since the tip end side of the outer cylinder is formed by the air permeable capturing portion, it is possible to capture surplus raw material while maintaining the air flow accompanying the blowout and suction of the raw material. Therefore, the possibility that the raw material scatters to the outside of the nozzle can be further reduced.

According to an embodiment of the disclosure, the air permeable capturing portion includes a brush that has a plurality of brush bristles (for example, the brush bristles 15 of the embodiment) extending in an axial direction. According to this configuration, since the tip end side of the outer cylinder is formed by the brush extending in the axial direction, it is possible to efficiently provide the air permeable capturing portion within the radial thickness of the outer cylinder. Therefore, the possibility that the raw material scatters to the outside of the nozzle can be further reduced.

According to an embodiment of the disclosure, the brush includes a bristle removed portion (for example, the bristle removed portion 16 of the embodiment) from which the brush bristles are removed or sparsely formed in a part of the outer cylinder in a circumferential direction. According to this configuration, since the bristle removed portion is provided in a part of the area of the brush, while reducing the possibility that the raw material scatters to the outside of the nozzle, the suction force of the outer cylinder can be weakened by providing the bristle removed portion from which the brush bristles are removed or sparsely formed. As a result, the raw material blown out from the inner cylinder can be prevented from being excessively attracted to the side of the outer cylinder.

### Effects

According to the disclosure, it is possible to provide a material layer forming device that can reduce the scattering of the raw material blown out from the nozzle to efficiently deposit the raw material on the required portion of the blowout target surface.

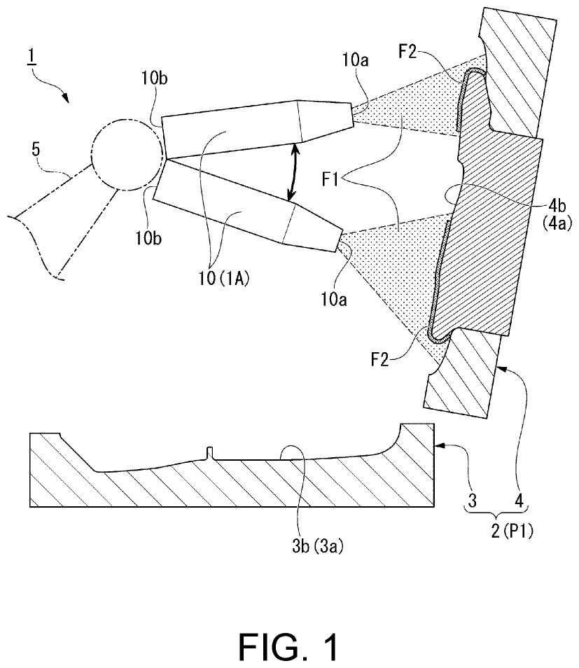

Hereinafter, an embodiment of the disclosure will be described with reference to the drawings. As schematically shown in FIG. 1 to FIG. 3, a fiber layer forming device 1A of the embodiment is applied to, for example, a molding apparatus 1 of a urethane pad which is a cushion material for an automobile seat. A molded product W obtained by the molding apparatus 1 has a urethane impregnated cured layer WB, which is a fiber reinforcing layer, integrally formed on at least a part of a surface (surface layer) of a urethane foam body WA. The urethane impregnated cured layer WB is locally harder than other portions containing only urethane, and is provided in a portion in contact with a seat frame, for example.

The molding apparatus 1 includes a mold 2 for molding the urethane foam body WA and molding the urethane impregnated cured layer WB on the surface of the urethane foam body WA, and a nozzle 10 for spraying a short fiber material (hereinafter, simply referred to as short fibers F1) as a reinforcing material of the urethane impregnated cured layer WB to at least a part of a wall surface of the mold 2 facing a cavity 2C. Examples of the short fibers F1 include the following fibers, that is, organic synthetic fibers such as cellulose fibers, PET fibers or PA fibers obtained by crushing paper or the like. In addition, the fiber length is preferably 20 mm or less, and more preferably 10 mm or less. From the viewpoint of transportability of short fibers, the fiber length is preferably 5 mm or less. Further, although organic synthetic fibers generally use a surfactant to prevent static charge, in the application of this embodiment, organic synthetic fibers without an antistatic treatment or organic synthetic fibers that are dried after washing and removing an antistatic treatment agent are preferable for the convenience of charging and adsorbing the fibers to an insulating filter layer of the mold. As the short fibers to be used, it is desirable to use fibers that have undergone a process such as hot air drying.

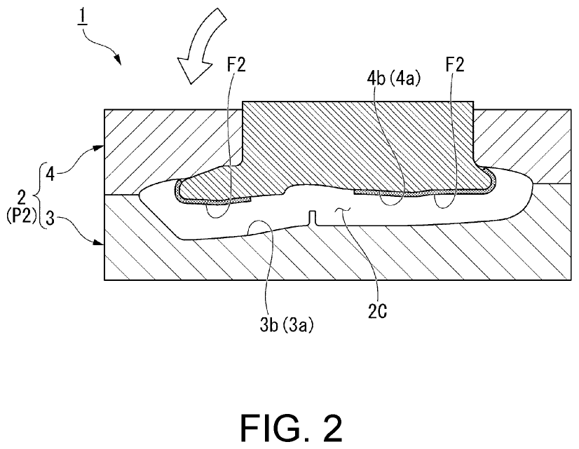

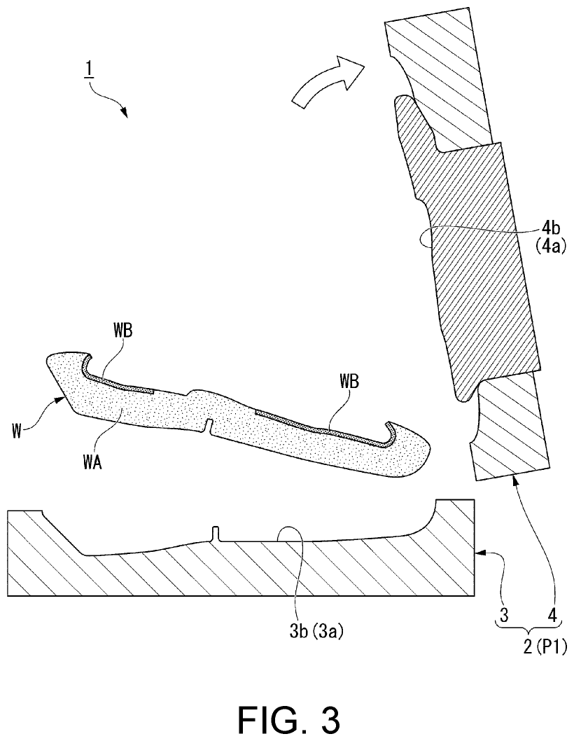

The mold 2 is movable between an opened state P1 shown in FIG. 1 and FIG. 3 and a mold clamped state P2 shown in FIG. 2. In the drawings, the reference numeral 3 indicates a fixed mold fixed to a fixed platen, and the reference numeral 4 indicates a movable mold that is movable with respect to the fixed mold 3. The fixed mold 3 has a recess 3a recessed on the fixed platen side. A wall surface 3b of the recess 3a is a surface for forming a design surface of the molded product W.

The movable mold 4 is operated by the operation of a displacement mechanism (for example, a hydraulic cylinder) (not shown) together with a movable platen, and approaches or separates from the fixed mold 3. When the movable mold 4 approaches the fixed side, the mold 2 is closed (mold clamped). The movable mold 4 has an opposing portion 4a that faces the recess 3a of the fixed mold 3 at the time of mold clamping. The cavity 2C is formed inside the mold 2 by the recess 3a and the opposing portion 4a. A wall surface 4b of the opposing portion 4a is a surface for forming a back surface of the molded product W opposite to the design surface.

The wall surface 4b of the movable mold 4 has air permeability which allows air to flow through, for example, by drilling a large number of holes. The movable mold 4 can suck air into the movable mold 4 from the holes of the wall surface 4b with a negative pressure generator (not shown). By sucking air to the wall surface 4b of the movable mold 4, the short fibers F1 blown out from the nozzle 10 can be adsorbed to the wall surface 4b to form a fiber layer F2 on the wall surface 4b.

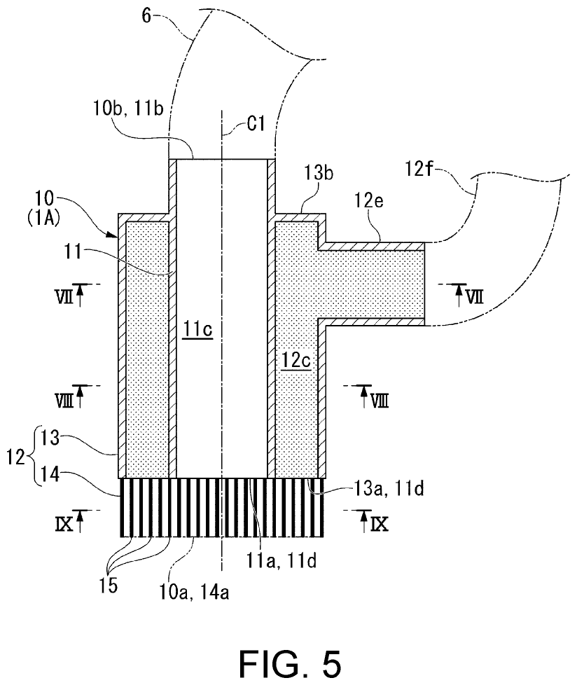

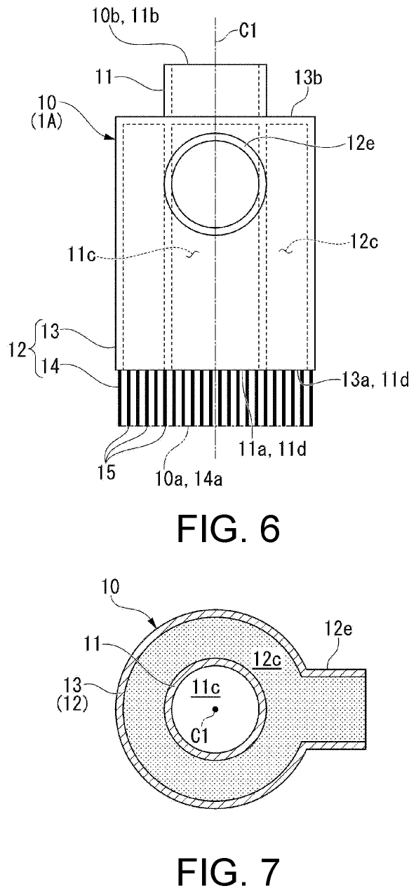

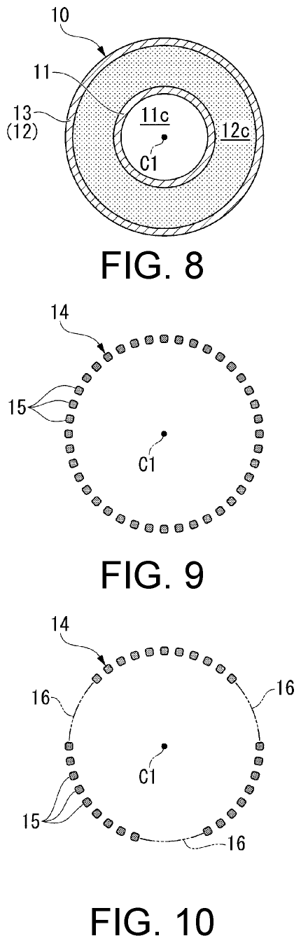

As shown in FIG. 5 to FIG. 9, the nozzle 10 has, for example, a cylindrical shape and the axial base end side thereof is held by a robot arm 5 (see FIG. 1). Charged short fibers F1 are supplied to the nozzle 10 together with transportation air. An axial tip end portion 10a of the nozzle 10 is provided with a blowout port 11d for blowing out the supplied short fibers F1. A flexible pipe 6 extending from a material supply device (not shown) is connected to a base end portion 10b of the nozzle 10. Hereinafter, the axial tip end and the axial base end of the nozzle 10 are simply referred to as a tip end and a base end, respectively. In the drawings, the reference numeral 11b indicates the base end portion of an inner cylinder 11 located at the base end portion 10b of the nozzle 10, and the reference numeral C1 indicates a central axis along the axial direction of the nozzle 10.

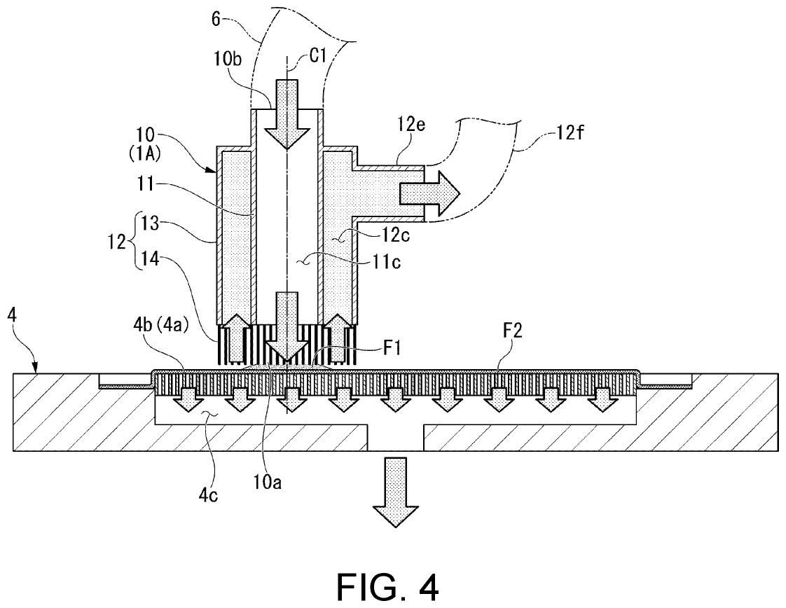

Also referring to FIG. 4, by the operation of the robot arm 5, the nozzle 10 directs the tip end portion 10a to face a predetermined specified portion of the wall surface 4b of the movable mold 4 of the mold 2 in the opened state P1. At this time, for example, the axial direction of the nozzle 10 is turned to the normal direction of the wall surface 4b. The short fibers F1 are sprayed from the blowout port 11d of the tip end portion 10a of the nozzle 10 toward the wall surface 4b of the movable mold 4. By depositing the short fibers F1 on the wall surface 4b, the fiber layer F2 having a specified thickness is formed on the wall surface 4b of the movable mold 4. The fiber layer F2 is adsorbed to the wall surface 4b by the wall surface 4b of the movable mold 4 sucking air. A suction passage 4c is formed in the movable mold 4 so as to suck air on the wall surface 4b.

When the formation of the fiber layer F2 on the wall surface 4b of the movable mold 4 is completed, various insert parts are set in the mold 2 and a urethane liquid is injected into the recess 3a of the fixed mold 3. Thereafter, the movable mold 4 of the mold 2 in the opened state P1 is superposed on the fixed mold 3 and clamped, and the urethane liquid is heat-treated together with the mold 2. As a result, the urethane is foamed and cured in the cavity 2C formed by the recess 3a of the fixed mold 3 and the wall surface 4b of the movable mold 4, and the molded product W having a specified shape is formed.

As shown in FIG. 5 to FIG. 9, the nozzle 10 has a double tube structure with inner and outer cylinders 11 and 12. For example, the inner and outer cylinders 11 and 12 each have a cylindrical shape and are arranged coaxially with each other. The internal space of the inner cylinder 11 is set as a blowout region 11c for blowing out the short fibers F1. A space between the inner and outer cylinders 11 and 12 is provided to surround the blowout region 11c. The space between the inner and outer cylinders 11 and 12 forms an annular shape having a constant radial width. The space between the inner and outer cylinders 11 and 12 is set as a suction region 12c for sucking and collecting the short fibers F1 spreading outside the blowout region 11c in the vicinity of the blowout region 11c. The circular blowout port 11d that opens toward the tip end side (the lower side in the drawing) of the nozzle 10 is formed at the tip end portion of the blowout region 11c (the tip end portion 11a of the inner cylinder 11). An annular suction port 12d that opens toward the tip end side of the nozzle 10 is formed around the blowout port 11d at the tip end portion of the suction region 12c.

As a result, the short fibers F1 that are about to scatter radially outward from the tip end portion 10a of the nozzle 10 are sucked and collected in the suction region 12c. Therefore, the possibility that the short fibers F1 scatter around the specified portion of a blowout target surface (the wall surface 4b of the movable mold 4) is reduced. A suction pipe 12e extends radially outward to the outside of the outer cylinder 12. A flexible pipe 12f extending from a fiber recovery device (not shown) is connected to the suction pipe 12e. The short fibers F1 collected by the fiber recovery device are returned to the material supply device to be blown out from the nozzle 10 again.

The outer cylinder 12 includes a cylindrical outer cylinder body 13 and a brush 14 formed by extending brush bristles 15 from a tip end portion 13a of the outer cylinder body 13 to the tip end side of the nozzle 10. That is, the portion on the tip end side of the outer cylinder 12 is formed by the brush 14. In the drawing, the reference numeral 13b indicates the base end portion of the outer cylinder body 13. The base end portion 13b of the outer cylinder body 13 is located on the tip end side with respect to the base end portion 11b of the inner cylinder 11, and is closed in the axial direction. For convenience of illustration, the brush bristles 15 are shown thick and rough.

The tip end portion 11a of the inner cylinder 11 that forms the blowout region 11c is located on the base end side with respect to the tip end portion (a tip end portion 14a of the brush 14) of the outer cylinder 12 that forms the suction region 12c. In other words, the tip end portion 11a of the inner cylinder 11 has a shorter axial length than the tip end portion (the tip end portion 14a of the brush 14) of the outer cylinder 12. The tip end portion 11a of the inner cylinder 11 (the tip end portion of the blowout region 11c) is set as the circular blowout port 11d. In the embodiment, the annular suction port 12d is located at the same axial position as the blowout port 11d. However, the annular suction port 12d may be provided at the same axial position as the tip end portion 13a of the outer cylinder body 13. The blowout region 11c and the suction region 12c may be regarded as extending in the axial direction also inside the brush 14.

A case where the tip end portion 10a of the nozzle 10 (the tip end portion 14a of the brush 14) is brought close to the wall surface 4b of the movable mold 4 to form the fiber layer F2 will be described with reference to FIG. 4. In this case, the short fibers F1 blown out from the blowout port 11d of the tip end portion 11a of the inner cylinder 11 toward the wall surface 4b are adsorbed to the wall surface 4b and deposited. At this time, some of the blown out short fibers F1 tend to spread radially outward with respect to the blowout region 11c and scatter radially outside the nozzle 10. In the embodiment, the short fibers F1 spreading outside the blowout region 11c are quickly captured and collected in the suction region 12c arranged close to the outer periphery of the blowout region 11c.

The brush 14 forming the tip end side of the nozzle 10 constitutes a brush-like frame for preventing fiber scattering. The brush 14 is an example of an air permeable capturing portion that has air permeability and can capture the short fibers F1. The tip end side of the outer cylinder 12 of the nozzle 10 is formed by the brush 14. The tip end portion of the outer cylinder 12 (the tip end portion 14a of the brush 14) is located on the axial tip end side with respect to the tip end portion 11a of the inner cylinder 11. Therefore, when the fiber layer F2 is formed on the wall surface 4b, the brush 14 approaches the wall surface 4b. As a result, the air carrying the short fibers F1 can be easily released to the outside of the blowout region 11c (easily exhausted), and the short fibers F1 spreading outside the blowout region 11c can be captured. Further, the suction region 12c can suck air from the outside of the brush 14, and the suction force of the suction region 12c for the blowout region 11c can be adjusted.

The brush 14 arranges a large number of brush bristles 15 along the circumferential direction of the outer cylinder body 13. The brush 14 may arrange the brush bristles 15 with equal density in the circumferential direction of the outer cylinder 12. As shown in FIG. 10, the brush 14 may have a bristle removed portion 16, from which the brush bristles 15 are removed with respect to other portions, in at least a part of the outer cylinder 12 in the circumferential direction. The bristle removed portion 16 has a form in which holes (cutouts) are provided in a part of the brush 14 in the circumferential direction. A plurality of bristle removed portions 16 may be provided at equal intervals in the circumferential direction. The bristle removed portion 16 has an effect of weakening the suction force for the short fibers F1 of the blowout region 11c by making it easy for the suction region 12c to suck the air outside the nozzle 10.

By adjusting the suction force of the suction region 12c with the bristle removed portion 16, it is possible to prevent the short fibers F1 of the blowout region 11c from being excessively attracted and sucked to the suction region 12c. The number of the bristle removed portions 16 is preferably 3 to 5, but not limited thereto. The bristle removed portion 16 is not limited to the form in which the brush bristles 15 are completely removed, but may also be a form in which the density of the brush bristles 15 is reduced (sparse). Further, the bristle removed portion 16 may have a form in which the length of the brush bristles 15 is shortened.

In addition, the axial position of the tip end portion 13a of the outer cylinder body 13 may be in the following form as long as the tip end portion of the outer cylinder 12 (the tip end portion 14a of the brush 14) extends toward the tip end side with respect to the tip end portion 11a of the inner cylinder 11. That is, the axial position of the tip end portion 13a of the outer cylinder body 13 may be the same as the axial position of the tip end portion 11a of the inner cylinder 11, may be on the base end side with respect to the tip end portion 11a of the inner cylinder 11 or may be on the tip end side with respect to the tip end portion 11a of the inner cylinder 11. For example, a plurality of nozzles 10 may be provided to shorten the process time for blowing out the short fibers F1. The quantity of the short fibers F1 blown out from the nozzle 10 can be adjusted by appropriately combining adjustments such as the residence time of the nozzle 10 and the pressure and flow rate of the transportation air in addition to the adjustment of the quantity of the short fibers F1 mixed into the transportation air.

Next, an operation when the molded product W, obtained by integrally forming the urethane impregnated cured layer WB on the surface of the urethane foam body WA, is produced by the fiber layer forming device 1A of the embodiment will be described. First, the mold 2 is set to the opened state P1, and the tip end portion 10a of the nozzle 10 (the tip end portion 14a of the brush 14) is brought close to the specified portion of the wall surface 4b of the opened movable mold 4. Next, the short fibers F1 are blown out from the nozzle 10 to the wall surface 4b in a state where the suction of air is started on the wall surface 4b. The short fibers F1 blown out from the nozzle 10 are adsorbed and deposited on the wall surface 4b. As a result, the fiber layer F2 is formed on the specified portion of the wall surface 4b of the movable mold 4. The fiber layer F2 is formed in a layer shape having a constant specified thickness on at least a part of the wall surface 4b.

The tip end portion 10a of the nozzle 10 is provided with the suction region 12c for sucking in surplus fibers in addition to the blowout region 11c for blowing out the short fibers F1. The suction region 12c is provided to surround the blowout region 11c. The short fibers F1 blown out from the blowout region 11c and colliding with the wall surface 4b tend to spread around the blowout region 11c along the wall surface 4b. At this time, the suction region 12c located outside the blowout region 11c favorably captures the short fibers F1 spreading outside the blowout region 11c.

In particular, when the short fibers F1 are deposited on the wall surface 4b and the height of the fiber layer F2 increases, the ventilation resistance of the air sucked to the wall surface 4b increases. As a result, the short fibers F1 easily scatter on the surface side of the fiber layer F2, but the scattering can be suppressed by the suction of the suction region 12c. In the embodiment, by reducing the scattering of the short fibers F1 to the outside of the nozzle 10, the short fibers F1 can be efficiently deposited on the specified portion of the wall surface 4b, and the fiber layer F2 having a uniform thickness can be efficiently formed.

Furthermore, the brush 14 is formed on the tip end side of the outer cylinder 12 that forms the suction region 12c by extending the brush bristles 15 from the tip end portion 13a of the outer cylinder body 13. The brush 14 brings the tip end portion 14a made of the brush bristles 15 close to or into contact with the wall surface 4b. When the brush 14 approaches or comes into contact with the wall surface 4b, it is possible to prevent the short fibers F1 from scattering to the outside of the outer cylinder 12 without obstructing the blowing out of the short fibers F1. That is, the short fibers F1 can be captured by the brush 14 while the transportation airflow blown out from the blowout region 11c is released to the outside of the brush 14.

When the formation of the fiber layer F2 on the wall surface 4b is completed, the insert parts are set in the mold 2 and the urethane liquid is injected. Thereafter, the mold 2 is clamped, and at that time, the suction of air to the wall surface 4b is continued. As a result, the fiber layer F2 is kept adsorbed to the wall surface 4b, and the positional deviation of the fiber layer F2 is prevented. After mold clamping, the urethane is foamed and cured in the cavity 2C to obtain the urethane foam molded product W having a specified shape. The fiber layer F2 held on the wall surface 4b is impregnated with the urethane liquid in the cavity 2C, and then heat-treated at the time of urethane molding to be integrally formed as the surface layer of the molded product W. The fiber layer F2 is cured at the time of urethane foam molding to form the urethane impregnated cured layer WB which is locally harder than other portions containing only urethane. That is, by forming the fiber layer F2 in advance on the specified portion of the wall surface 4b, the urethane impregnated cured layer WB harder than other portions can be formed.

As described above, the fiber layer forming device 1A according to the above embodiment is a device that blows out the short fibers F1 to the blowout target surface (the wall surface 4b) and deposits the short fibers F1 on the blowout target surface to form the sheet-like fiber layer F2, and includes the nozzle 10 having the blowout region 11c for blowing out the short fibers F1. The nozzle 10 further includes the suction region 12c that is close to the blowout region 11c and sucks the short fibers F1 spreading to the outside of the blowout region 11c, among the short fibers F1 blown out from the blowout region 11c. According to this configuration, since the short fibers F1 blown out from the nozzle 10 are less likely to scatter around the nozzle 10, the possibility that the thickness of the fiber layer F2 becomes uneven due to the scattered short fibers F1 can be suppressed.

In the above-described fiber layer forming device 1A, the suction region 12c is provided to surround the outside of the blowout region 11c when viewed from the blowout direction of the nozzle 10. According to this configuration, since the short fibers F1 can be quickly sucked outside the blowout region 11c before the short fibers F1 scatter to the outside of the nozzle 10, the possibility that the short fibers F1 scatter to the outside of the nozzle 10 can be further suppressed.

In the above-described fiber layer forming device 1A, the nozzle 10 includes the inner cylinder 11 forming the blowout region 11c inside, and the outer cylinder 12 provided on the outer periphery of the inner cylinder 11 at an interval and forming the suction region 12c with the inner cylinder 11. The axial tip end portion 14a of the outer cylinder 12 (brush 14) facing the blowout target surface is provided on the axial tip end side with respect to the axial tip end portion 11a of the inner cylinder 11 facing the blowout target surface. According to this configuration, the nozzle 10 has a double tube structure including the inner and outer cylinders 11 and 12, and the inner cylinder 11 forms the blowout region 11c and the outer cylinder 12 forms the suction region 12c. Since the outer cylinder 12 of the nozzle 10 is provided to be longer than the inner cylinder 11 on the tip end side in the axial direction, it is easy to capture the short fibers F1 spreading to the outside of the blowout region 11c, and the possibility that the short fibers F1 scatter to the outside of the nozzle 10 can be further suppressed.

In the above-described fiber layer forming device 1A, the portion on the axial tip end side of the outer cylinder 12 is provided with the air permeable capturing portion (brush 14) that has air permeability and can capture the short fibers F1. According to this configuration, since the tip end side of the outer cylinder 12 is formed by the brush 14 serving as the air permeable capturing portion, it is possible to capture the surplus short fibers F1 while maintaining the air flow accompanying the blowout and suction of the short fibers F1. Therefore, the possibility that the short fibers F1 scatter to the outside of the nozzle 10 can be further reduced.

In the above-described fiber layer forming device 1A, the air permeable capturing portion is formed by the brush 14 that has a plurality of brush bristles 15 extending in the axial direction. According to this configuration, since the tip end side of the outer cylinder 12 is formed by the brush 14 extending in the axial direction, it is possible to efficiently provide the air permeable capturing portion within the radial thickness of the outer cylinder 12. Therefore, the possibility that the short fibers F1 scatter to the outside of the nozzle 10 can be further reduced.

In the above-described fiber layer forming device 1A, the brush 14 includes the bristle removed portion 16 from which the brush bristles 15 are removed or sparsely formed in a part of the outer cylinder 12 in the circumferential direction. According to this configuration, since the bristle removed portion 16 is provided in a part of the area of the brush 14, while reducing the possibility that the short fibers F1 scatter to the outside of the nozzle 10, the suction force of the outer cylinder 12 can be weakened by providing the bristle removed portion 16 from which the brush bristles 15 are removed or sparsely formed. As a result, the short fibers F1 blown out from the inner cylinder 11 can be prevented from being excessively attracted to the side of the outer cylinder 12.

Nevertheless, the disclosure is not limited to the above embodiment. For example, a porous urethane foam, a mesh material or the like that has air permeability may be provided in place of the brush 14 to serve as a scatter preventive frame (the air permeable capturing portion) provided on the tip end side of the outer cylinder 12. That is, any scatter preventive frame with a structure that has air permeability and can capture the short fibers F1 may be used. Although the embodiment shows an example of application to the urethane foam molding apparatus 1, the disclosure may also be applied to an apparatus for molding a fiber aggregate formed by laminating synthetic fibers, for example, instead of urethane foam. The short fibers F1 may have various materials and sizes (length and thickness) as long as they can be carried by air. Further, the disclosure may be applied to a material layer forming device that uses not only a fiber material but also a particle-like or powder-like raw material. The configuration in the above embodiment is an example of the disclosure, and it is possible to make various modifications without departing from the gist of the disclosure, such as replacing the constituent elements of the embodiment with well-known constituent elements.

What is claimed is:

1. A material layer forming device for blowing out a raw material to a blowout target surface and depositing the raw material on the blowout target surface to form a sheet-like material layer, the material layer forming device comprising:
a nozzle having a blowout region that blows out the raw material,
wherein the nozzle further comprises a suction region that is close to the blowout region and sucks the raw material spreading to outside of the blowout region, among the raw material blown out from the blowout region.

2. The material layer forming device according to claim 1, wherein the suction region is provided to surround the outside of the blowout region when viewed from a blowout direction of the nozzle.

3. The material layer forming device according to claim 1, wherein the nozzle comprises:
an inner cylinder that forms the blowout region inside; and
an outer cylinder that is provided on an outer periphery of the inner cylinder at an interval and forms the suction region between the inner cylinder and the outer cylinder,
wherein an axial tip end portion of the outer cylinder facing the blowout target surface is provided on an axial tip end side with respect to an axial tip end portion of the inner cylinder facing the blowout target surface.

4. The material layer forming device according to claim 3, wherein a portion on an axial tip end side of the outer cylinder is provided with an air permeable capturing portion that has air permeability and is capable of capturing the raw material.

5. The material layer forming device according to claim 4, wherein the air permeable capturing portion comprises a brush that has a plurality of brush bristles extending in an axial direction.

6. The material layer forming device according to claim 5, wherein the brush comprises a bristle removed portion from which the brush bristles are removed or sparsely formed in a part of the outer cylinder in a circumferential direction.

7. The material layer forming device according to claim 2, wherein the nozzle comprises:
an inner cylinder that forms the blowout region inside; and
an outer cylinder that is provided on an outer periphery of the inner cylinder at an interval and forms the suction region between the inner cylinder and the outer cylinder,
wherein an axial tip end portion of the outer cylinder facing the blowout target surface is provided on an axial tip end side with respect to an axial tip end portion of the inner cylinder facing the blowout target surface.

8. The material layer forming device according to claim 7, wherein a portion on an axial tip end side of the outer cylinder is provided with an air permeable capturing portion that has air permeability and is capable of capturing the raw material.

9. The material layer forming device according to claim 8, wherein the air permeable capturing portion comprises a brush that has a plurality of brush bristles extending in an axial direction.

10. The material layer forming device according to claim 9, wherein the brush comprises a bristle removed portion from which the brush bristles are removed or sparsely formed in a part of the outer cylinder in a circumferential direction.
